(19) United States
(12) Patent Application Publication
(10) Pub. No.: US 2016/0128305 A1
(43) Pub. Date: May 12, 2016

(54) Device and Method for Rolling up a Cable

(71) Applicant: DAG ACHT B.V., Amersfoort (NL)

(72) Inventors: Rutger Dave van Overbeek, Amersfoort (NL); Arno Christiaan Alexander Zwaag, Amstelveen (NL)

(21) Appl. No.: 14/988,300

(22) Filed: Jan. 5, 2016

Related U.S. Application Data
(63) Continuation of application No. PCT/NL2014/050449, filed on Jul. 4, 2014.

(30) Foreign Application Priority Data
Jul. 5, 2013 (NL) 2011105

(51) Int. Cl. A01K 27/00; B65H 75/48; B65H 75/44

(52) U.S. Cl. CPC A01K 27/004; B65H 75/4423; B65H 75/48

(57) ABSTRACT

A device for rolling up and unwinding a leash, comprising a housing, a leash, a coil within the housing and embodied for rolling up the leash around the coil, an opening for guiding the leash in and out of the housing, a spring acting upon the coil for rolling up the leash by means of spring force and for unwinding the leash against the spring force. The device further comprises a retaining means coupled to the leash within the housing that is adjustable between a leash coupling state and a disconnected state, wherein the device comprises a catch means near the opening for catching the retaining means when unwinding the leash.

### CROSS-REFERENCE TO RELATED APPLICATIONS

This application is a continuation application of Patent Cooperation Treaty Application No. PCT/NL2014/050449, filed on Jul. 4, 2014, which claims priority to Netherlands Patent Application No. 2011105, filed Jul. 5, 2013, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention (Technical Field)

The present invention relates to a device and method for rolling up a leash.

2. Description of Related Art

Such a device is known in the art. For example, US2008/0011895 in the name of Flexi Bogdahn describes a device for rolling up a dog leash on a coil by means of pretension and, against said pretension, unwinding said dog leash from said coil. A dog that is coupled to said leash will easily be able to unwound said leash for obtaining more freedom of movement. The advantage of such device with respect to a traditional dog leash is that the leash will be kept tight all the time, regardless the distance between the dog and his attendant. Of course, the maximum distance is limited to the length of the leash. Due to the winding mechanism, the attendant or any other person will not become entangled, as is the case with traditional leashes. In cases wherein the dog is only allowed to be at a limited distance from the attendant, the Flexi Bogdahn device comprises a stopping mechanism that stops the coil from running. As a consequence, the leash cannot be unwound any further, thus limiting the dog's freedom of movement. However, a disadvantage is that the leash cannot be rolled up either. When the dog moves towards the attendant, the leash will slack, such that the disadvantage of a traditional leash is obtained.

### BRIEF SUMMARY OF THE INVENTION

The present invention aims at providing an improved device of the kind mentioned in the preamble. The invention is directed to a device and a method for rolling up and unwinding a leash. The term “leash” relates to any kind of belt or cable that can be wound on a coil, for example flat and round belts or cables. The invention will hereafter be described by means of a dog leash. However, the invention is not limited to such use. The invention is neither limited to a certain shape of said leash, even though the invention will be described mainly with reference to a flat cable, a generally known dog leash. Such cables may be used as a leash, especially for pets like dogs and cats.

The invention especially aims at providing a device as mentioned above providing the possibility of limiting the maximum freedom of movement of an animal, for example a dog, and that effectively prevents the effect of slack of said leash. However, the invention is not limited to dog leashes, as explained before.

The invention especially aims at providing a device with which ease of operation is obtainable between a full freewheeling of the leash for providing the dog the opportunity to use the entire length of the leash and a limited freedom of movement wherein only part of the leash' length is available to the dog.

Further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE SEVERAL VIEWS OF THE DRAWINGS

The accompanying drawings, which are incorporated into and form a part of the specification, illustrate one or more embodiments of the present invention and, together with the description, serve to explain the principles of the invention. The drawings are only for the purpose of illustrating one or more preferred embodiments of the invention and are not to be construed as limiting the invention. In the drawings:

FIG. 1 is a first schematic view of a part of a device according to the present invention;

FIG. 2 is a second schematic view of a part of a device according to the present invention;

FIG. 3 is a detailed view of a part of a device according to the present invention; and

FIG. 4 is another detailed view of a part of a device according to the present invention.

### DETAILED DESCRIPTION OF THE INVENTION

So as to obtain at least one of the aims mentioned above, the invention provides according to a first embodiment a device comprising the features of claim 1. This device has the advantage that a provision is attained for simply limiting the freedom of movement of a dog. The retaining means may be connected, or clamped, to the leash and will be wound onto the coil, together with the leash. When the leash is unwound, the retaining means, when leaving the winding on the coil and is directed towards the opening, will be retained by said catch means. As a consequence, further unwinding of said leash is prevented. The freedom of movement of a dog is herewith effectively limited.

It is further preferred for the device to comprise a control means for toggling said retaining means between a coupling state and a disconnected state. Then, a user may easily choose between providing the dog with unlimited freedom of movement of limiting said movement. By connecting, or clamping, said retaining means to said leash by means of said control means when a dog has unwound a maximum allowable part of said leash, the limited freedom of movement is set.

A preferred embodiment is obtained by means of a device comprising a coupling actuator that is adjustable between at least two states, chosen from a state wherein said leash is connected to said retaining means and a state wherein said leash is disconnected from said leash. By using two states, a user may choose between the retaining means being coupled to said leash and a state wherein said retaining means is disconnected from said leash.

A simple operation is obtained if said device comprises a control means at an outside of said housing for controlling said coupling actuator.

A secure operation is obtained, with only limited chance of disconnection of said retaining means from said leash, if said retaining means comprises a spring-loaded clamping lever, a clamping end thereof abutting said leash in a spring-loaded state.

So as to be able to easily and quickly disconnect said retaining means, it is preferred that said retaining means comprises a spring-loaded clamping lever, a clamping end thereof being positioned at a distance from said leash in a spring-loaded state.

An efficient movement of the leash towards the coil, especially both when the leash has been wound substantially on said coil and when said leash has been unwound from said coil, is obtained when the catch means comprises an exit directed towards said opening and an entrance directed towards said coil, said catch means being coupled tiltable to said housing, such that the entrance can be directed substantially to a leash's winding position on said coil. The term “a leash's winding position on said coil” refers to the position the leash contacts the coil or the position the leash contacts a part of the leash that has already been wound on said coil. In case of a substantially completely unwound leash said position is more closely to the coil's rotational axis than in case of a substantially wound leash. The angle at which the leash runs from the opening towards the winding on the coil therefore varies widely during winding and unwinding said leash.

According to a further aspect of the present invention, a method is provided for using a leash, comprising the step of providing a device according to any of the preceding claims. As a matter of fact, according to the invention, the method may also comprise the step of connecting an animal to a leash' end positioned outside said device. The aims as mentioned before will be obtained effectively and efficiently.

It is especially preferred for the method to comprise the step of controlling said control means for connecting, more in particular clamping, said retaining means to said leash, so as to limit the maximum freedom of movement of said dog, without obtaining slack in said leash in case the dog moves towards his attendant.

The invention will now be described with reference to the drawings. In the figures, the same parts are identified by the same reference numbers. However, for ease of understanding the figures, not all parts that are required for a practical embodiment may have shown. Furthermore, not all parts have been shown in the proper proportion. Some parts have been shown enlarged with respect to other parts in order to ease the explanation of the invention.

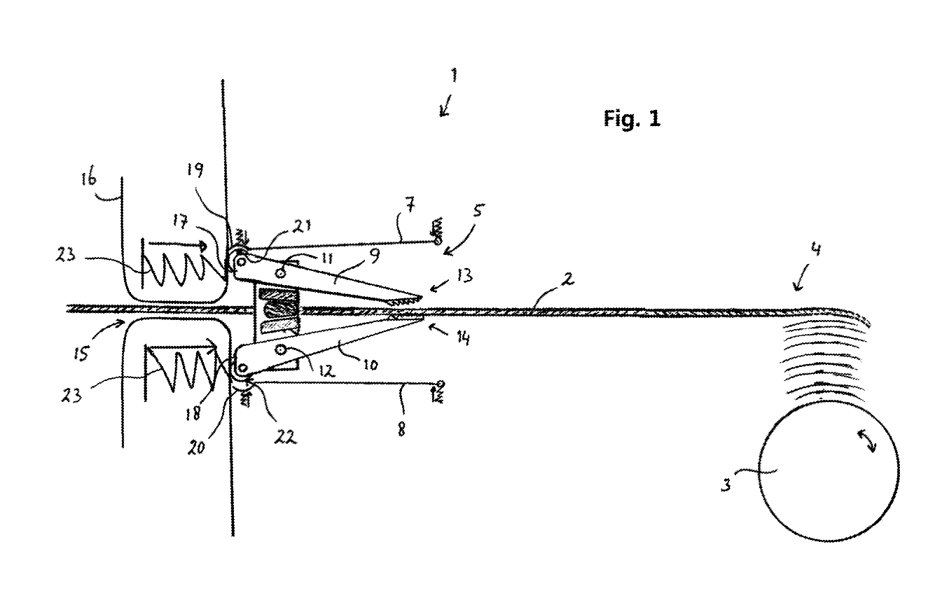

FIG. 1 shows a first schematic view of a part of a device 1 for winding and unwinding a leash 2 according to the invention. Although reference is made substantially to a dog leash 2, the device 1 is primarily suitable for winding and unwinding other belts as well. Also, the term “leash” not only refers to a substantially flat belt but also to circular and otherwise shaped cross-sectional shapes.

The device 1 comprises a coil 3 for winding thereon the leash 2. The winding position 4 is the position where the leash 2 contacts the partially wound coil. A retaining means 5 has been connected to the leash 2. Said retaining means 5 can be connected securely to the leash 2, such that said retaining means 5 is wound on the coil 3 together with the leash 2. Upon unwinding the leash 2 from the coil 3 said retaining means 5 will become released. Further unwinding of said leash 2 makes the retaining means 5 abut a catch means 6, stopping the retaining means 5. Since the retaining means 5 has been securely connected to the leash 2, the leash 2 will no further unwind from the coil. As a result, it is effectively ensured that the leash will only be unwound partially, such that a dog connected to the leash only has a limited freedom of movement.

In the embodiment shown in FIG. 1, the catch means has two guiding legs 7, 8 that can be moved towards the leash 2, and consequently towards the retaining means 5, if same is positioned between legs 9, 10. Said legs 9, 10 each comprise a pivot-axis 11, 12 along which they may pivot, such that a clamping end 13, 14 may be positioned abutting said leash or may be moved from such position. When the clamping ends 13, 14 abut said leash 2, the retaining means 5 will be connected securely to the leash 2. The retaining means 2 may be wound on the coil 3, together with the leash. Since an opening 15 has been provided in housing 16 of device 1, through which the leash 2 may be guided out of housing 16, retaining means 5 will not be able to leave said housing.

The connection (usually a clamping) of retaining means 5 to said leash may be disconnected by acting a force on an end 17, 18 of legs 9, 10 directed away from clamping end 13, 14, at another side of said pivot-axis 11, 12 than the side of said clamping ends 13, 14. As a result, the clamping ends 13, 14 are shifted away from leash 2 such that said clamping action is cancelled and leash 2 may move freely between legs 9, 10 of said retaining means.

The legs 9, 10 are preferably preloaded by means of a compression spring, which ensures that the legs 9, 10 will abut the leash 2 with their clamping ends 13, 14 in non-loaded state.

The guiding legs 7, 8 preferably comprise receiving means 19, 20 that are embodied for cooperation with lugs 21, 22 that are connected to said retaining means 5. By moving the guiding legs 7, 8 towards the leash when the retaining means 5 is positioned between said legs, the lugs 21, 22 will be received in said receiving means 19, 20, with the consequence that said retaining means 5 is clamped in catch means 6. This has the consequence that the leash will be guided freely between the legs of retaining means 5, yielding a maximum freedom of movement. For example, the guiding legs 7, 8 may be positioned against said retaining means by means of a control means to be controlled by a user (not shown in FIG. 1). When the user uses the control means for activating said retaining means 5 by clamping same against the leash 2, the maximum freedom of movement will be limited, depending on the extent to which the leash was unwound at the moment of activating said retaining means.

FIG. 1 furthermore shows a shock absorber 23 dampening shocks on housing 16 when leash 2 is unwound and retaining means 5 abuts catch means 6. Housing 16 of device 1 may also be manufactured from a resiliently stretching material such that said housing itself may serve as a shock absorber. A separate shock absorber 23 may then be omitted.

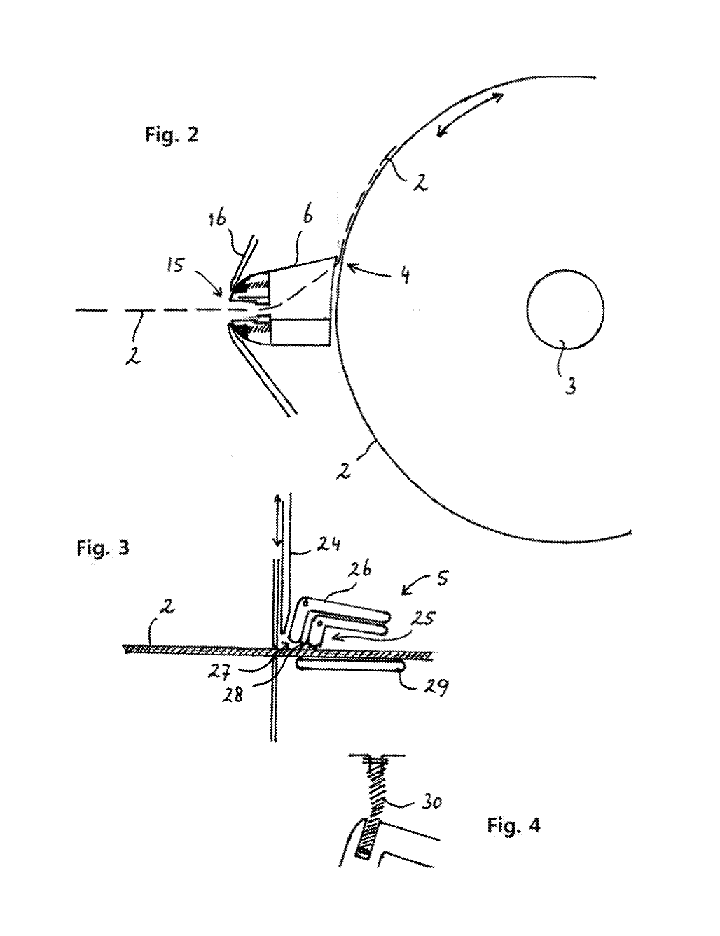

FIG. 2 shows a second schematic view of a part of a device 1 according to the invention. The leash 2 has been indicated schematically in a discontinuous line and has been wound on coil 3 substantially completely. A catch means 6 has been positioned near opening 15 in housing 16, such that said catch means 6 is pivotable so as to be able to guide said leash 2 regularly towards said winding position 4 on coil 3.

In FIG. 3 a schematic, alternative embodiment of a retaining means 5 has been shown. A control rod 24 is provided for positioning a retaining means 25 against leash 2 by means of an intermediate actuator 26. When moving said control rod 24 towards leash 2, the end 27 of said actuator 26 is pushed against the end 28 of retaining means 25. In cooperation with base part 29 of retaining means 5, said retaining means 5 is clamped against leash 2.

Finally, FIG. 4 shows a detailed view of a possible compression spring 30 so as to keep legs 9, 10 in a preloaded state to-wards leash 2. One of ordinary skill in the art will be easily capable of choosing a connecting position and spring rate, suitable for its purpose.

The device and the respective parts thereof may be manufactured from a plastic or a metal, or a combination thereof. Also, natural materials may be applied for manufacturing the device or parts thereof.

The invention is not limited to the embodiments as described above and as shown in the drawing. The invention is limited only by the appending claims. The device according to the present may comprise an additional brake allowing the leash at any time to be secured fixedly so as to prevent any further unwinding and/or winding thereof.

The invention also embodies every combination of features that have been described herein independently of each other.

What is claimed is:

1. A device for rolling up and unwinding a leash, the device comprising a housing, a leash, a coil within said housing and embodied for rolling up said leash around said coil, an opening for guiding said leash in and out of said housing, a spring acting upon said coil for rolling up said leash by means of spring force and for unwinding said leash against said spring force, a retaining means coupled to said leash within said housing that is adjustable between a leash coupling state and a disconnected state, and a catch means near said opening for catching said retaining means when unwinding said leash.

2. The device according to claim 1, further comprising a control means for toggling said retaining means between a coupling state and a disconnected state.

3. The device according to claim 1, further comprising a coupling actuator that is adjustable between at least two states, chosen from a state wherein said leash is connected to said retaining means and a state wherein said leash is disconnected from said leash.

4. The device according to claim 3, further comprising a control means at an outside of said housing for controlling said coupling actuator.

5. The device according to claim 1, wherein said retaining means comprises a spring-loaded clamping lever, a clamping end thereof abutting said leash in a spring-loaded state.

6. The device according to claim 1, wherein said retaining means comprises a spring-loaded clamping lever, a clamping end thereof being positioned at a distance from said leash in a spring-loaded state.

7. The device according to claim 1, further comprising an exit directed towards said opening and an entrance directed towards said coil, said catch means being coupled tiltable to said housing such that the entrance can be directed substantially to a leash's winding position on said coil.

8. A method for using a leash, the method comprising the steps of providing a device according to claim 1 and connecting an animal to a leash's end positioned outside said device.

9. The method according to claim 8, further comprising the step of controlling said control means for connecting said retaining means to said leash.
